(19) United States
(12) Patent Application Publication
(10) Pub. No.: US 2009/0226556 A1
(43) Pub. Date: Sep. 10, 2009

(54) INDIRECT COOLING STRUCTURE FOR MOLD

(76) Inventor: Chih-Cheng Lin, Hsin Chuang City (TW)

Correspondence Address: LEONG C LEI, PMB # 1008, 1867 YGNACIO VALLEY ROAD, WALNUT CREEK, CA, 94598, US

(21) Appl. No.: 12/045,034

(22) Filed: Mar. 10, 2008

(51) Int. Cl. B29C 45/73; B29C 45/14

(52) U.S. Cl. 425/552

(57) ABSTRACT

A molding device includes a male mold and a female mold. The female mold is set opposite to the male mold and forms and a displacement bore and includes insert, which is provided with a heating device, and has a coupling portion. A fixing board is arranged above and coupled to the female mold by at least one guide post, which extends into the displacement bore of the female mold. The fixing board is provided with a cooling metal block, which is extendable into the coupling portion of the female mold to engage the insert to thereby allow the cooling metal block to absorb the heat of the molds for dissipation and thus efficiently lowering the temperature of the molds. The heating device provides thermal energy to set the molds at the optimum temperature for injection molding.

### BACKGROUND OF THE INVENTION

(a) Technical Field of the Invention

The present invention relates to an indirect cooling structure for a molding device, which comprises a female mold that forms a displacement bore, a coupling portion, and an insert, the insert being provided with a heating device, a fixing board being provided above the female mold and comprising a guide post extending into the displacement bore and carrying a cooling metal block that is extendable into the coupling portion of the female mold to engage the insert whereby the engagement of the cooling metal block with the insert allows the cooling metal block to absorb the temperature of the molds and dissipates heat therefrom to efficiently lower the temperature of the molds, the heating device of the insert providing the molds with an optimum temperature for injection molding to make a molded product having a smooth and seamless surface, so that indirect cooling and heating structure for a molding device can be realized.

(b) Description of the Prior Art

With reference to FIGS. 1 and 2, which respectively illustrate the conditions of a molding device before and after operation, the molding device comprises a male mold 11 and a female mold 12. The female mold 12 forms a product cavity 121. Fluid passages 122 are formed around the cavity 121 to allow liquid or gas to flow therethrough for providing the desired temperature for molding operation.

The conventional molding device, although effectively providing the desired molding temperature for molding operation, is not able to provide both heating and cooling operations. Thus, when the fluid flowing through the passages 122 is set at a high temperature, a molded product 14 that is molded with the molding device that is set at a high temperature, at least partly by the fluid, can form a smooth and seamless surface. However, such a setting of high temperature makes the curing of the product 14 is difficult and lasting for a long time. On the other hand, when the fluid inside the passages 122 is set at a low temperature, the product 14 made by injection molding with the molding device is easy to shape and cure, yet the surface of the product 14 so made exhibits an obvious seam line 13 as shown in FIG. 3. This may often consider a defeat product.

Taiwan Patent Application No. 095222419 discloses an improvement of a cooling system for injection mold, wherein a cooling water device is coupled to two cooling circuits formed on a stationary mold and a movable mold and the cooling circuit is arranged in a body of the stationary mold (or the movable mold) and comprises a main water inlet tube, a main water outlet tube and multiple sets of cooling circuit units. Each cooling circuit unit comprises a branch inlet tube, a branch outlet tube and cooling tube coil. Each branch inlet tube has an end connected to the main water inlet tube and an opposite end connected to the cooling tube coil. An opposite end of the cooling tube coil is connected to the branch outlet tube and an opposite end of the branch outlet tube is connected to the main water outlet tube.

Such a known device, however, is based on fluid flowing through the cooling circuits to set the temperature during the molding operation and is still incapable to realize instantaneous heating and cooling. Thus, the device still surfers the same problem that a high temperature setting makes curing difficult and a low temperature setting causing formation of surface seam line 13 (see FIG. 3) to thereby making the final product defeated.

This, it is desired to have an indirect cooling structure for molds that realizes efficient heating/cooling to overcome the above discussed problem.

### SUMMARY OF THE INVENTION

The primary purpose of the present invention is to provide an indirect cooling structure for a molding device, comprising a male mold; a female mold arranged to be opposite to the male mold and forming a cavity, the female mold further forming a displacement bore and comprising an insert, the insert being provided with a heating device, the female mold further forming a coupling portion; and a fixing board arranged above the female mold and coupled to the female mold by at least one guide post, the guide post extending into the displacement bore of the female mold, the fixing board being provided with a cooling metal block, which is extendable into the coupling portion of the female mold and engageable with the insert, whereby the engagement of the engagement of the cooling metal block with the insert allows the cooling metal block to absorb the temperature of the molds and dissipates heat therefrom to efficiently lower the temperature of the molds. The heating device of the insert provides the molds with an optimum temperature for injection molding to make a molded product having a smooth and seamless surface, so that indirect cooling and heating structure for a molding device can be realized.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 schematically illustrates a conventional molding device in a condition before operation;

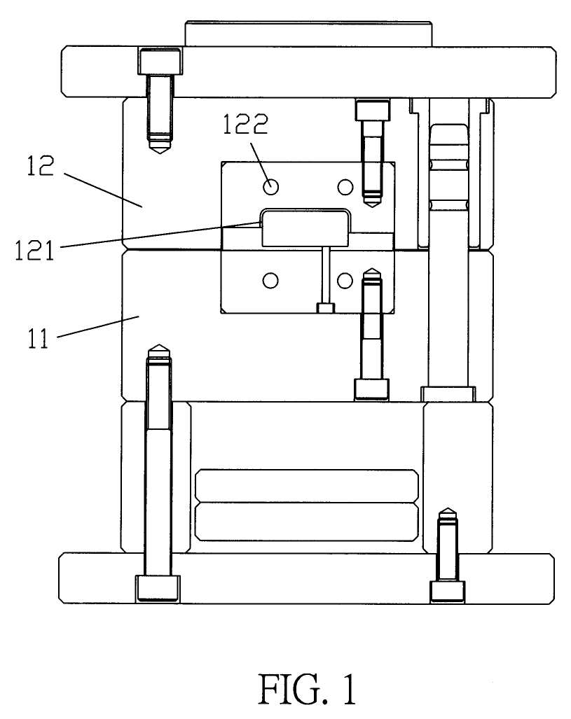

FIG. 2 schematically illustrates the conventional molding device in a condition after the operation;

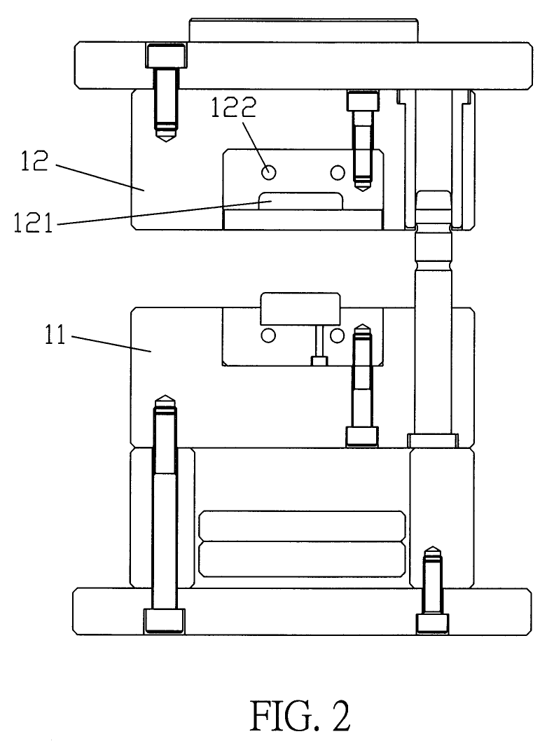

FIG. 3 schematically illustrates a molded product made by the conventional molding device;

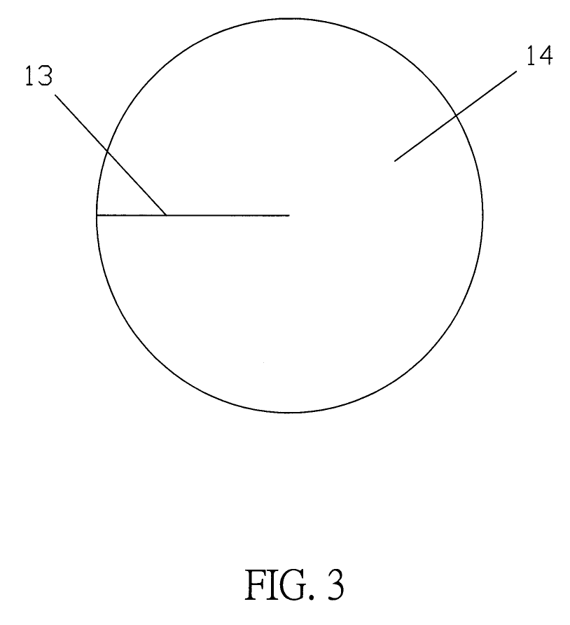

FIG. 4 schematically illustrates the present invention before operation;

FIG. 5 schematically illustrates the present invention in a heating condition during the operation thereof;

FIG. 6 schematically illustrates the present invention in a cooling condition during the operation thereof;

FIG. 7 schematically illustrates the present invention after the operation; and

FIG. 8 schematically illustrates a product molded in accordance with the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

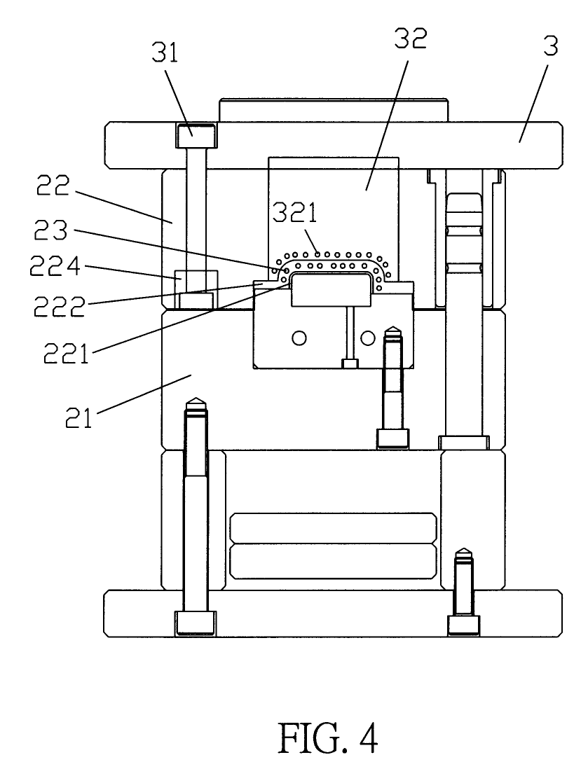

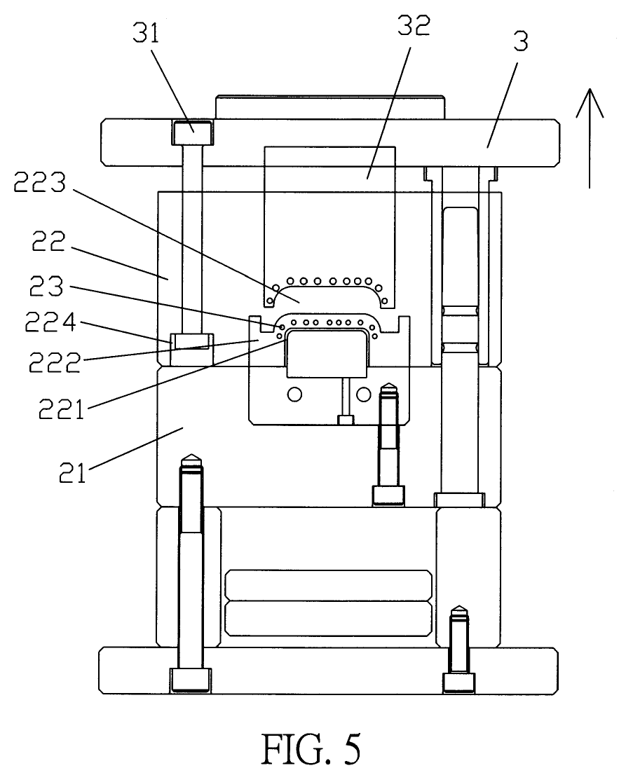

With reference to the drawings and in particular to FIG. 4, the present invention provides an indirect cooling structure that is applicable to a molding device comprises a male mold 21 and a female mold 22. The female mold 22 is set opposite to the male mold 21 and forms a product cavity 221. The female mold 22 also forms a displacement bore 24 and an insert 222. The insert 222 is provided with a heating device 23 and the heating device 23 is arranged around the cavity 221. The heating device 23 can be any known heating measure, such as a heating wire. The female mold 22 is further provided with a coupling portion 223, as shown in FIG. 5.

A fixing board 3 is arranged above the female mold 22 and is coupled to the female mold 22 through at least one guide post 31. The guide post 31 extends through the female mold 22 into the displacement bore 224. The fixing board 3 is provided with a cooling metal block 32, which can be made of for example copper or aluminum. The cooling metal block 32 extends into the coupling portion 223 of the female mold 22. The cooling metal block 32 has a lower edge that is complementary in shape and size to an upper edge of the insert 222.

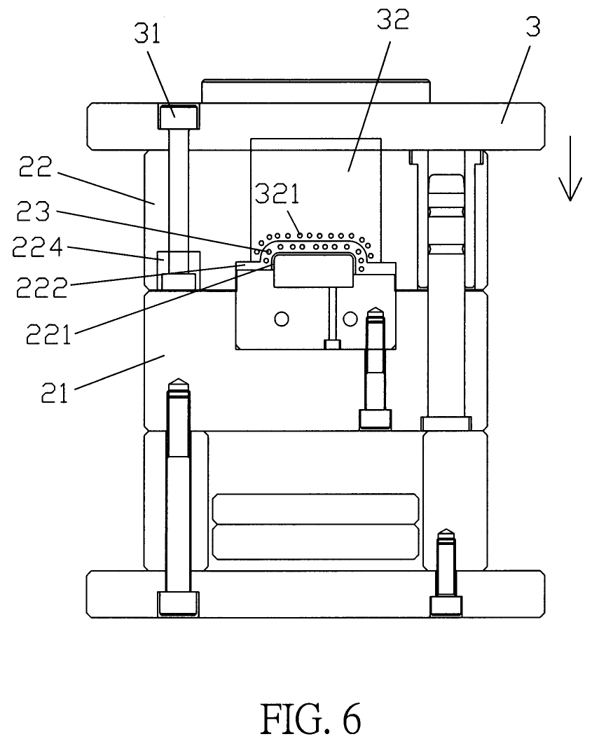

Still referring to FIG. 4, when the female mold 22 is driven and moved by the molding device to clamp to the male mold 21. The cavity 221 that is present between the female mold 22 and the male mold 21 can be injected with material for carrying out injection molding operation. Further referring to FIG. 5, the molding device moves the fixing plate 3 away from the female mold 22 to have a lower end of the guide post 31 of the fixing board 3 set at an upper limit location defined by an upper end of the displacement bore 224 of the female mold 22. The cooling metal block 32 that is fixed to the fixing board 3 is also moved and thus separated from the insert 222. At the same time, control means (not shown) controls the heating device 23 that is arranged in the insert 222 to carry out heating operation to efficiently raise the temperature of the mold, causing the temperature inside the cavity 221 raised to an optimum temperature for injection. Also referring to FIG. 6, when the injected plastic material completely bonds together, the fixing board 3 is moved again by the molding device to engage the female mold 22 with the lower end of the guide post 3 getting lowered to a lower end of the displacement board 224 of the female mold 22, making the cooling metal block 32 fixed to the fixing board 3 also moved and getting tight engagement with the insert 222. At the same time, the control device shut off the heating operation of the heating device 23 of the insert 222. With the cooling metal block 32 that is made of a material of high thermal conductivity, the temperature of the mold can be efficiently transmitted to the cooling metal block 32 for dissipation thereby realizing indirect cooling.

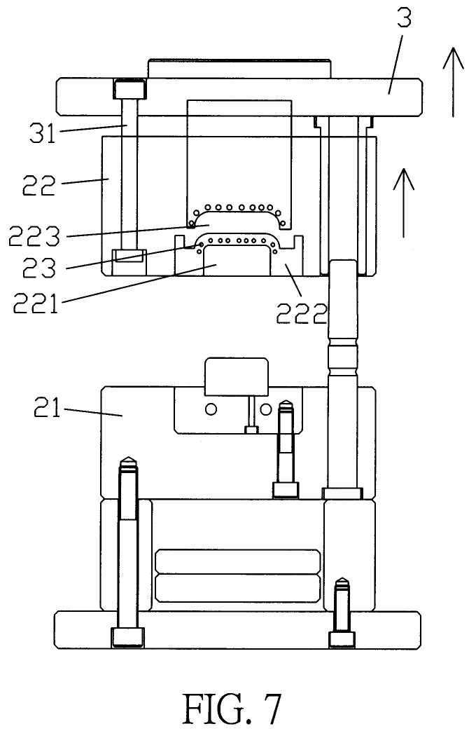

Also referring to FIG. 7, when the injection molding operation is completed, the female mold 22 is driven and moved by the molding device to separate from the male mold 21 to allow removal of the molded product 14. As shown in FIG. 4, the cooling metal block 32 is provided with fluid passages 321 through which a fluid flows to absorb and carry away the heat that is transmitted to the cooling metal block 32 to thereby efficiently lower down the temperature of the cooling metal block 32.

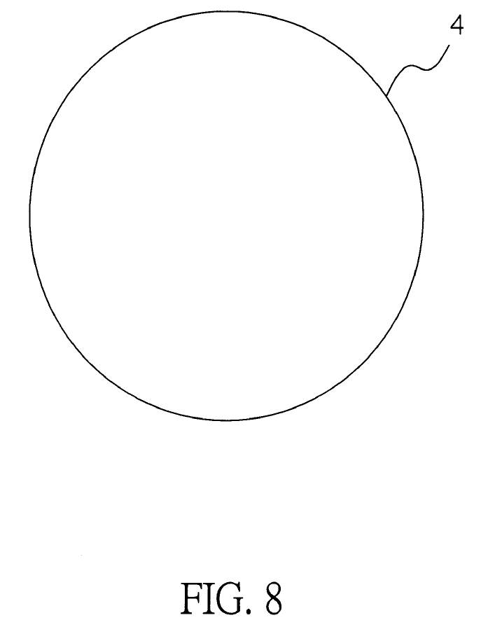

With the present invention, the mold is capable of both heating and cooling and the product 4 molded therefore has a smooth and seamless surface and has a high product passing rate, as illustrated in FIG. 8. Thus, the present invention realizes an indirect cooling structure, which is also capable of heating, for a mold.

A comparison with the conventional techniques reveals that the conventional techniques have disadvantages, such as:

(1) The conventional mold can only use the material of the mold itself for heat transmission, which leads to poor efficiency of heat transmission.

(2) The conventional mold only uses the temperature of the liquid flowing through the fluid passages formed therein to set the temperature for molding operation.

(3) The temperature for molding operation cannot fast change in the conventional mold, making it difficult to efficiently heating and cooling.

(4) When the temperature of the liquid flowing through the fluid passages formed inside the mold, the molded product is difficult to cure and the curing may last for too long.

(5) When the temperature of the liquid flowing through the fluid passages formed inside the mold, the molded product may form a jointing seam on a surface thereof.

On the other hand, the present invention exhibits at least the following advantages:

(1) An efficient heat transmission path is established by using an additional material that is of high heat transmission efficiency to thereby enhance the performance of heat dissipation.

(2) The temperature for molding operation can be fast changed for efficiently heating and cooling.

(3) The problem of being difficult to cure or formation of surface seam line can be effectively overcome.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A molding device comprising:
a male mold;
a female mold arranged to be opposite to the male mold and forming a cavity, the female mold further forming a displacement bore and comprising an insert, the insert being provided with a heating device, the female mold further forming a coupling portion; and
a fixing board arranged above the female mold and coupled to the female mold by at least one guide post, the guide post extending into the displacement bore of the female mold, the fixing board being provided with a cooling metal block, which is extendable into the coupling portion of the female mold.

2. The molding device as claimed in claim 1, wherein the heating device of the insert of the female mold comprises a heating wire.

3. The molding device as claimed in claim 1, wherein the heating device of the insert of the female mold is arranged around the cavity.

4. The molding device as claimed in claim 1, wherein the cooling metal block of the fixing board comprises copper.

5. The molding device as claimed in claim 1, wherein the cooling metal block of the fixing board comprises aluminum.

6. The molding device as claimed in claim 1, wherein the cooling metal block of the fixing board forms therein passage for fluid.

7. The molding device as claimed in claim 1, wherein the cooling metal block of the fixing board has a lower edge that is shaped and sized complementary to an upper edge of the insert.
